(19) United States
(12) Patent Application Publication
(10) Pub. No.: US 2011/0127245 A1
(43) Pub. Date: Jun. 2, 2011

(54) Soap saver

(76) Inventor: Leon Burrus, Baltimore, MD (US)

(21) Appl. No.: 12/927,959

(22) Filed: Nov. 30, 2010

Related U.S. Application Data
(60) Provisional application No. 61/283,161, filed on Nov. 30, 2009.

(51) Int. Cl. H05B 1/00

(52) U.S. Cl. 219/201

(57) ABSTRACT

The Soap Saver consists of a rectangular receptacle, similar in appearance to industrial soap dispensers. The Soap Saver is manufactured of heavy duty plastic or metal material and features electronic components, powered by a standard 9-volt battery. Incorporated into the design of the unit is an internally contained heating element which functions to soften soap placed inside the device. Along with a dispensing button, a simple on/off switch is also included for use in activating the unit.

### CLAIM OF PRIORITY

This patent application claims priority under 35 USC 119 (e) (1) from U.S. Provisional Patent Application Ser. No. 61/283,161 filed Nov. 30, 2009, of common inventorship herewith entitled, “Soap Saver.”

### FIELD OF THE INVENTION

The present invention pertains to the field of bathroom accessories, and more specifically to the field of soap, and even more specifically to the field of reclaiming used soaps for re-use.

### BACKGROUND OF THE INVENTION

The prior art has put forth several designs for reclaiming used soaps for re-use. Among these are:

U.S. Pat. No. 328,714 to John C. Ralston describes an apparatus for re-melting soap comprising a small melting vessel for heating and re-forming used soaps.

U.S. Pat. No. 3,215,642 to Jacob M. Levy describes a lather making machine.

U.S. Pat. No. 4,030,867 to Don D. Everman describes an apparatus for forming a bar of soap from leftover pieces.

None of these prior art references describe the present invention.

### SUMMARY OF THE INVENTION

It is an object of the present invention to provide an improved device for reclaiming used soaps.

### BRIEF DESCRIPTION OF THE DRAWINGS

FIG. 1 is a front view of the device of the present invention.

FIG. 2 is a back view of the device of the present invention.

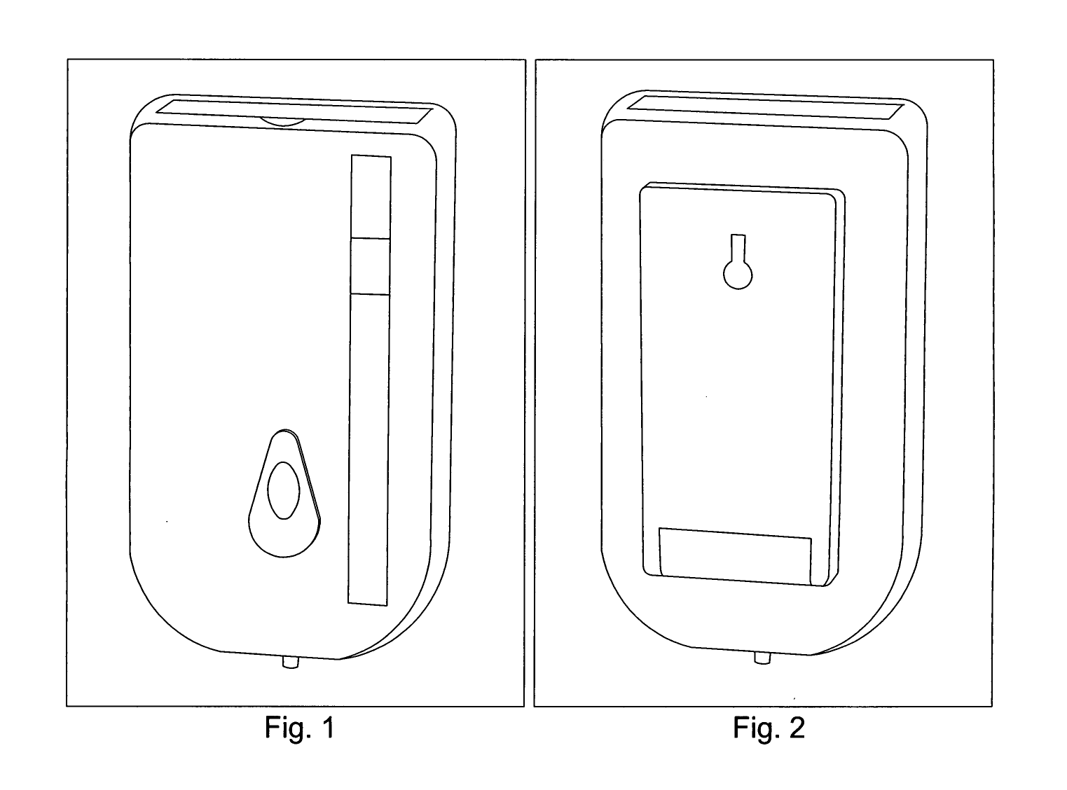

### DETAILED DESCRIPTION OF THE INVENTION

One of the most commonly wasted product in any household is bar soap. Quickly deteriorating in soap dishes and underneath running shower stalls, a large, expensive bar of soap can end up a small, seemingly worthless sliver in a manner of a few days. Extremely soft and small, these slivers of soap can be extremely difficult to handle and therefore impractical to use. Additionally, once a bar of soap has dissolved into small pieces, it can become easily trapped in drainage systems and plumbing, resulting in costly repair bills. Because of this, most consumers simply toss their slivers of soap in the garbage, rather than deal with the hassle of attempting to fully utilize them.

The present invention, hereinafter referred to as the Soap Saver, is an innovative invention which offers consumers a simple means of saving money within the home by enabling them to efficiently utilize entire bars of soap. The Soap Saver is a specially designed dispensing unit configured with an internal heating mechanism that turns the soap into liquid form.

The Soap Saver consists of a rectangular receptacle, similar in appearance to industrial soap dispensers. The Soap Saver is manufactured of heavy duty plastic or metal material and features electronic components, powered by a standard 9-volt battery. Incorporated into the design of the unit is an internally contained heating element which functions to soften soap placed inside the device. Along with a dispensing button, a simple on/off switch is also included for use in activating the unit.

Use of the Soap Saver is very simple and straight forward. This product can be used with virtually any brand, scent or style bar soap or combinations thereof. First, the user simply utilizes their favorite soap per normal, using the soap in the shower, bath or in a sink basin. As the soap deteriorates in size and texture, the user tosses the remaining sliver into the Soap Saver unit. Gradually collecting several slivers of soap, the user adds these slivers until Soap Saver is completely filled. Next, the user powers the device via the on/off switch. Once activated, the internally contained heating elements serve to soften the soap contained within. The user then presses the dispensing button, allowing the soap to be utilized in the same manner as any other liquid soap.

The Soap Saver is a cleverly designed invention which offers consumers many significant benefits and advantages. Foremost, this innovative product enables consumers to efficiently utilize entire bars of soap, thereby preventing unnecessary waste. Because of this important advantage, consumers who utilize the Soap Saver effectively save money. Compressing several small slivers of soap into liquid form, the Soap Saver proves a practical alternative to washing the body or hands with a tiny piece of slippery soap. Additionally, because the Soap Saver melts several small pieces of soap into liquid, use of this product effectively prevents these slivers from clogging the shower, bath or sink drain. Saving the expense and hassle of plumbing repairs, the Soap Saver proves a valuable commodity in any home. Simple to use, consumers will appreciate the easy application of this useful product. Durably constructed from heavy duty plastic materials, the Soap Saver will withstand years of repeated use.

Practical, the Soap Saver enables consumers to efficiently save money by preventing unnecessary waste within the home. Saving the consumer countless dollars spent on replacement products, this cleverly designed invention proves an invaluable accessory in any household.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A device for melting used soap, comprising a box-like receptacle comprising an openable lid, a means for hanging the device in a bathroom or shower and an internal heating element for melting soap; and further comprising a dispensing means activated by an external button, and an off/on switch for activating the heating element.

2. The device of claim 1 wherein the device is comprised of plastic material.

3. The device of claim 1 wherein the device is comprised of metal material.

4. The device of claim 1 wherein the heating element is powered by a 9 volt battery.

5. A method for reclaiming used soap comprising:
using bar soap until the size of the soap becomes a soap sliver, which is too small for easy use,
inserting the soap sliver into the top of the device of claim 1;
collecting several slivers of soap;
turning on the device by means of the off/on switch, allowing the heating element to melt the soap;
pressing the dispensing button, allowing the soap to be utilized in the same manner as any other liquid soap.
